(19) United States
(12) Patent Application Publication
(10) Pub. No.: US 2013/0313786 A1
(43) Pub. Date: Nov. 28, 2013

(54) Sealing Ring

(71) Applicants: Carlos Fangauf, Hamburg (DE); Marko Wrage, Struvenhuetten (DE)

(72) Inventors: Carlos Fangauf, Hamburg (DE); Marko Wrage, Struvenhuetten (DE)

(73) Assignee: Blohm + Voss Industries GmbH, Hamburg (DE)

(21) Appl. No.: 13/983,112

(22) PCT Filed: Apr. 13, 2012
(86) PCT No.: PCT/DE12/00394

§ 371 Date: Aug. 1, 2013

(30) Foreign Application Priority Data
May 24, 2011 (DE) 10 2011 102 477.1

(51) Int. Cl. F16J 15/32

(52) U.S. Cl. CPC F16J 15/32
USPC 277/402

(57) ABSTRACT

In seal rings for the sealing of shafts for propeller shafts, impeller shafts, rudder shafts of ships, an arrangement is provided, wherein a clamp-in element in allocated housing-fixed support rings as an installation space is provided with an adjoining intermediate part as a membrane and an angled element facing toward the shaft with formation of a seal lip for contact on the shaft. Thereby the contact region of the seal lip on the shaft is formed by a circle-shaped seal region with a constant radius over the entire adjustment range. Alternatively, the contact region of the seal lip on the shaft is formed by a circle-shaped seal region, whereby in the unloaded condition the seal region in the region facing toward the medium to be sealed comprises a smaller radius relative to a radius in the rearward region of the seal lip.

The invention relates to a seal ring for sealing shafts, especially of water against water or water against air, for propeller shafts, impeller shafts, rudder shafts of ships, consisting of a clamp-in element in allocated housing-fixed support rings as an installation space with an adjoining intermediate part as a membrane and an angled element facing toward the shaft with formation of a seal lip for contact on the shaft, whereby a receiving groove or trough with a spring is arranged in the angled element above the seal lip.

Shaft seals for sealing of this type are known in various different embodiments. According to the DE 37 42 080 C, there has been suggested a shaft seal for a ship's propeller shaft for sealing outside water against a gaseous medium with a ring-shaped seal lip of elastomeric material, whereby the seal region is embodied angularly with corners, in order to introduce a leakage of water through a gap between seal strip and shaft for improved lubrication. Furthermore, a lip seal of this type is known according to the DE 41 41 999, in which the contact force of the seal lip is not proportional to the pressure of the medium to be sealed, but rather increases degressively relative thereto.

It is the object of the invention to provide a simple embodiment for the seal region, which makes possible a rolling-along of a seal lip for reducing a line force increase in connection with increasing pressure loading.

The solution of this problem is achieved according to the invention in that the contact region of the seal lip on the shaft comprises through a circle-shaped seal region with a constant radius over the entire adjustment range.

Hereby relatively small contact angles in the front face side and bulkhead or back side region become possible, which remain identical with different adjustments and are advantageous for the sealing of low-viscosity liquids such as water.

Through the rolling movement of the seal lip, the radial hydraulically-effective surface also becomes smaller under pressure loading in comparison to conventional seal edges.

Alternatively it is suggested that the contact region of the seal lip on the shaft is formed by a circle-shaped seal region, whereby in the unloaded condition, the seal region in the region facing toward the medium to be sealed comprises a smaller radius relative to a radius in the rearward region of the seal lip.

In this embodiment, under pressure loading the contact angles become smaller due to turning or twisting of the seal lip and thereby the contact patch or region becomes wider. These two measures promote a stable lubrication guide embodiment, which is especially important at higher pressure loading. Thereby, the contact angles and the contact patch width adapt themselves to the prevailing pressure. Furthermore, the front face side contact angle is basically or fundamentally larger than the bulkhead side contact angle, so that an asymmetrical pressure distribution arises in the seal region. For certain low-viscosity liquids this is advantageous for the tribologic formation of the lubrication film.

In further development of the invention it is suggested that the ratio between the small radius relative to the large radius of the seal lip comprises a factor of 2 to 3.

Further it is provided that the radii form a transition on the central perpendicular of the shaft over the contact region of the seal lip in the unloaded condition.

Furthermore it is suggested that the transition of the different radii of the seal lip is embodied in a step-less or smooth manner.

Example embodiments of the invention are schematically illustrated in the drawing. It is shown by:

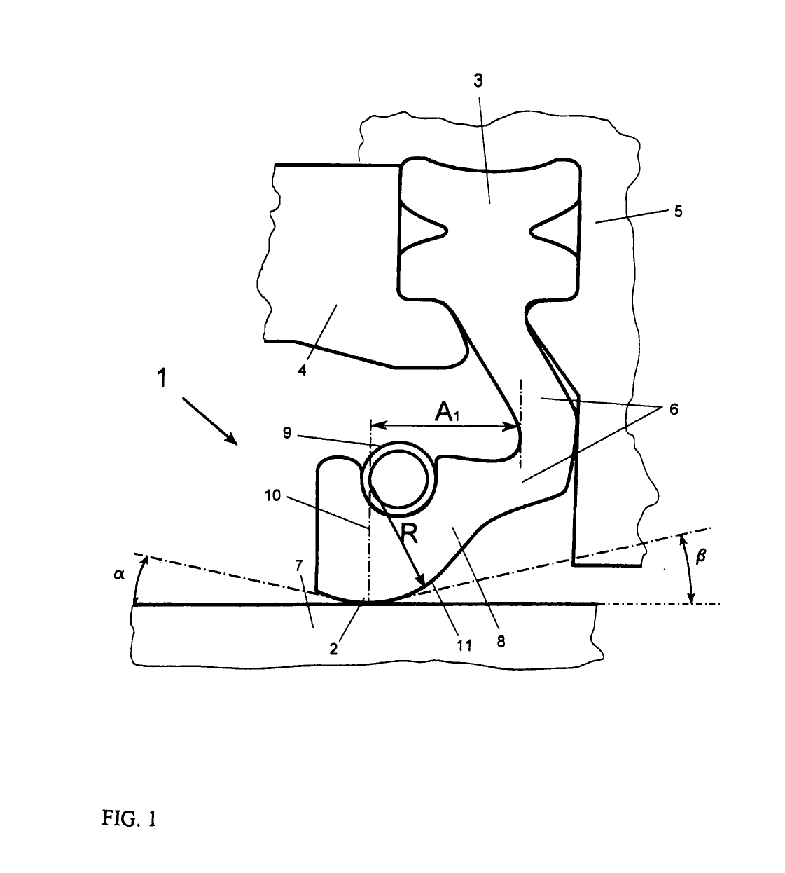

FIG. 1 an unloaded seal ring with a constant radius in the contact region of the seal lip;

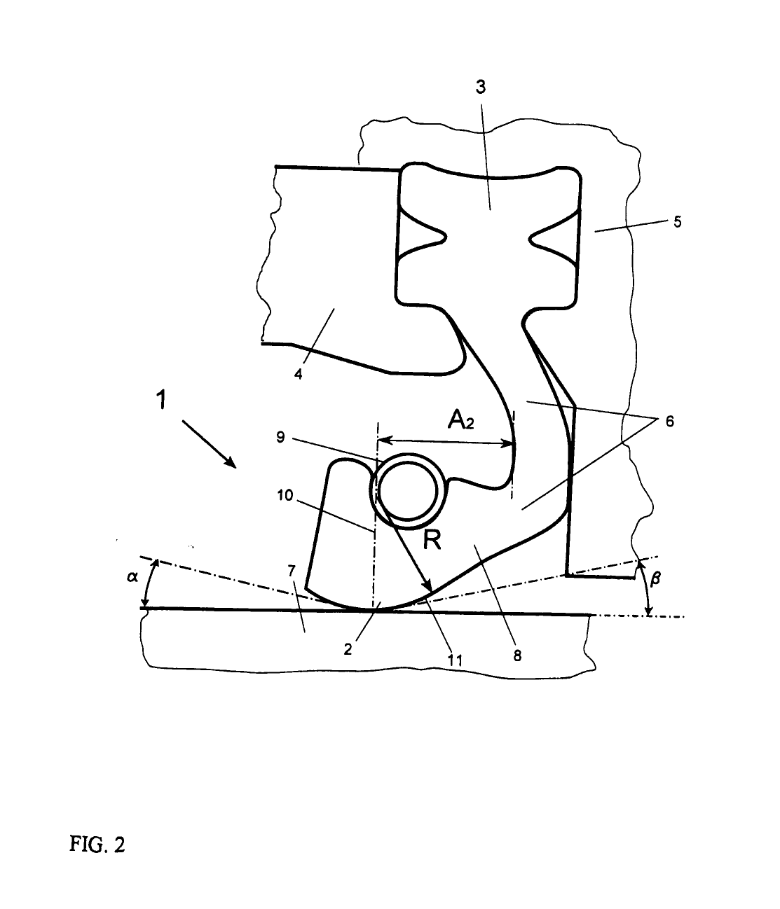

FIG. 2 a pressure loaded seal ring according to FIG. 1;

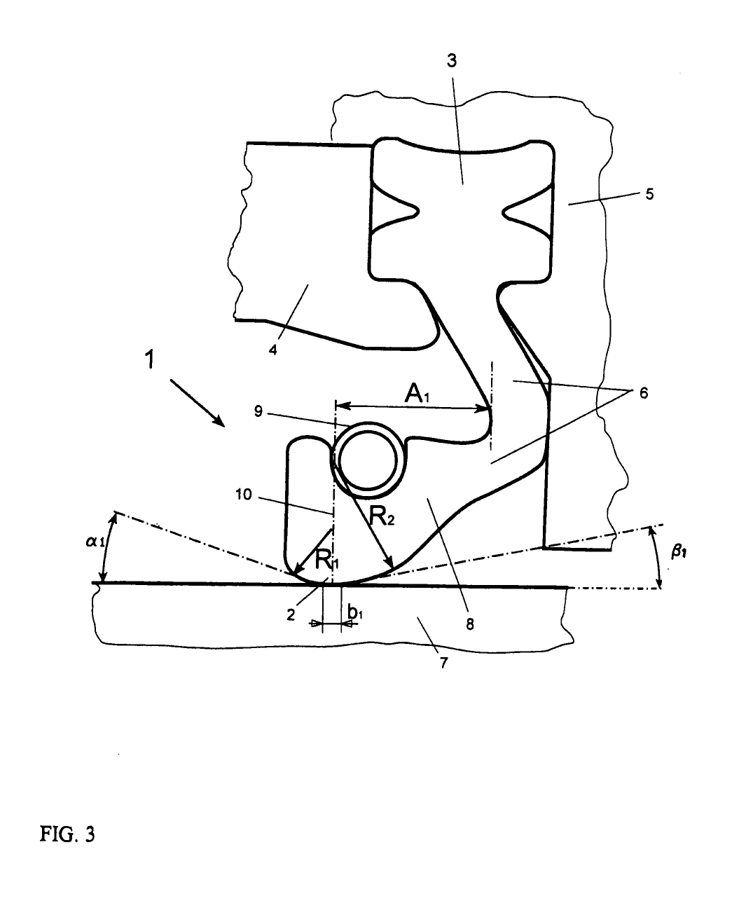

FIG. 3 a further embodiment of an unloaded seal ring with a smaller radius in the region facing toward the medium to be sealed relative to a radius in the rearward region of the seal lip; and

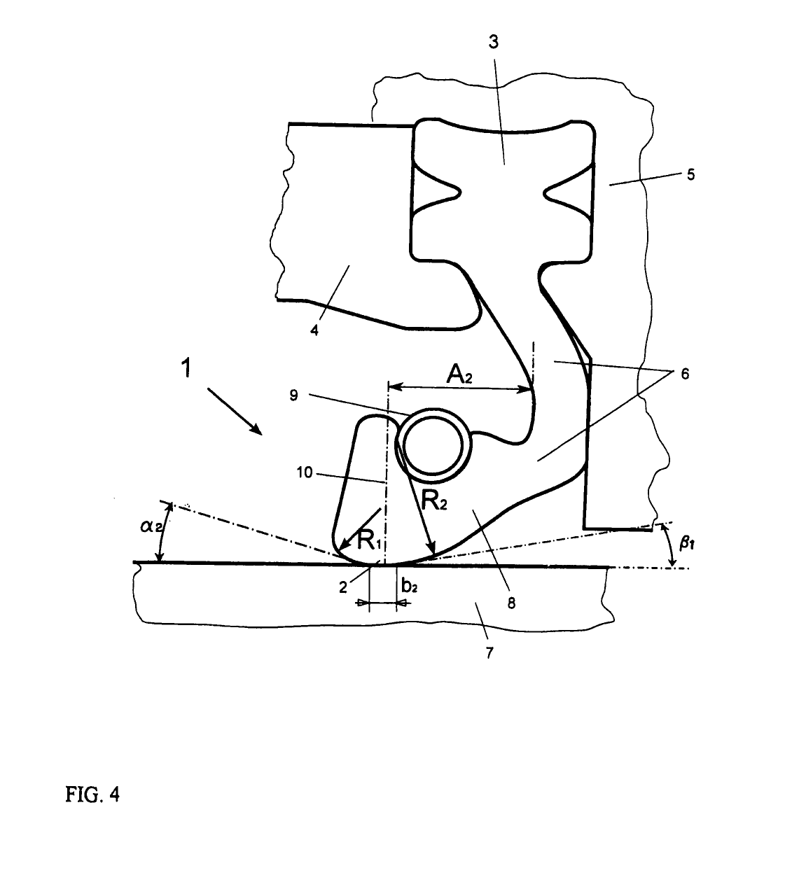

FIG. 4 a pressure loaded seal ring according to FIG. 3.

The illustrated seal rings 1 consist of an upper clamp-in element 3, which is clamped into housing-fixed metallic support rings 4, 5 in a liquid-tight known manner. An intermediate part 6 as a membrane, which is formed at an angle relative to a horizontal formed by a shaft 7, adjoins on the clamp-in part 3 of the seal 1.

The intermediate part 6 is connected with an angled region 8 of the seal that faces toward a shaft 7 to be sealed, and with its end region forms a seal lip 2, which contacts or lies on the shaft 7 with the front face side contact angle alpha and the bulkhead side contact angle beta.

According to FIGS. 1 and 2, the seal lip 2 is formed by a circle-shaped seal region 11 of the angled region 8 of the seal 1. This region has a constant radius R over the entire adjustment range of the seal lip 2, so that the contact angles alpha and beta are equal. The radius R has its starting point or center on the central perpendicular 10 of the shaft 7 over the contact region of the seal lip 2 in the unloaded condition.

The radius is usually dimensioned approximately at 3 mm for small seal rings and at approximately 15 mm for larger seal rings.

For forming a contact pressing pressure of the seal lip 2 on the shaft 7, an allocated spring 9 is provided besides the elastic return element of the angled region 8 of the seal ring 1. In that regard, the spring 9 is received in a receiving groove or trough as a spring pocket.

The equal contact angles alpha and beta are formed by the tangents in the contact region between seal lip 2 and shaft 7, and are thus accordingly relatively small. This is advantageous for the sealing of low-viscosity liquids such as water. The circle-shaped embodiment of the seal region, through the seal lip 2 and the deformation of the membrane 6, makes possible a rolling movement of the seal lip 2 on the shaft 7. The deformation of the membrane 6 can be caused by a pressure loading or by radial offset of the shaft. Thereby the contact angles alpha and beta remain unchanged. Due to the rolling movement (rolling along) of the seal lip 2, the radial hydraulically effective surface A becomes smaller under pressure loading (A₂<A₁). This causes a reduction of the line force increase upon increasing pressure loading in comparison to seal rings with a typical seal edge.

According to a further example embodiment according to FIGS. 3 and 4, the seal region is formed by the seal lip 2, in a deviating manner, by two differing radii R₁ and R₂. A smaller radius R₁ is arranged in the region toward the medium to be sealed, relative to the radius R₂ in the rearward region of the seal lip 2. The center points of the radii R₁ and R₂ lie on the central perpendicular 10 of the shaft 7 over the contact region of the seal lip 2 in the unloaded condition, and thereby form a step-less transition.

In that regard, the two radii R₁ and R₂ differ from one another by a factor of 2 to 3.

Due to the differing radii R₁ and R₂, under pressure loading the contact angles alpha and beta become smaller due to the turning of the seal lip, and simultaneously a contact patch or running track area b becomes wider (b₂<b₁). Both of these promote a more stable lubrication film formation, which is especially important at the higher pressure loading. Thus, the contact angles and the contact patch width adapt themselves to the prevailing pressure.

Moreover, through this embodiment, the angle alpha is basically or fundamentally larger than beta, which leads to an asymmetrical pressure distribution in the seal region. This can be advantageous for the tribologic formation of the lubrication film for certain low-viscosity liquids.

1. Seal ring for the sealing of shafts, especially of water against water or water against air, for propeller shafts, impeller shafts, rudder shafts of ships, consisting of a clamp-in element in allocated housing-fixed support rings as an installation space with an adjoining intermediate part as a membrane and an angled element facing toward the shaft with formation of a seal lip for contact on the shaft, whereby a receiving groove with a spring is arranged in the angled element above the seal lip, characterized in that the contact region of the seal lip (2) on the shaft (7) comprises a circle-shaped seal region with a constant radius (R) over the entire adjustment range.

2. Seal ring for the sealing of shafts, especially of water against water or water against air, for propeller shafts, impeller shafts, rudder shafts of ships, consisting of a clamp-in element in allocated housing-fixed support rings as an installation space with an adjoining intermediate part as a membrane and an angled element facing toward the shaft with formation of a seal lip for contact on the shaft, whereby a receiving groove with a spring is arranged in the angled element above the seal lip, characterized in that the contact region of the seal lip (2) on the shaft (7) is formed by a circle-shaped seal region, whereby in the unloaded condition the seal region comprises a smaller radius (R1) in the region facing toward the medium to be sealed, relative to a radius (R2) in the rearward region of the seal lip (2).

3. Seal ring according to claim 2, characterized in that the ratio between the small radius (R1) relative to the large radius (R2) of the seal lip (2) comprises a factor of 2 to 3.

4. Seal ring according to claim 2, characterized in that the radii (R1, R2) form a transition on the central perpendicular (10) of the shaft (7) over the contact region of the seal lip (2) in the unloaded condition.

5. Seal ring according to claim 4, characterized in that the transition of the differing radii (R1, R2) of the seal lip (2) is embodied step-less.
